(19) United States
(12) Patent Application Publication
(10) Pub. No.: US 2023/0220833 A1
(43) Pub. Date: Jul. 13, 2023

(54) Modular Wind Turbine

(71) Applicant: Steven Thompson, Callaway, MD (US)

(72) Inventor: Steven Thompson, Callaway, MD (US)

(21) Appl. No.: 17/572,760

(22) Filed: Jan. 11, 2022

(51) Int. Cl. F03D 15/20

(52) U.S. Cl. CPC F03D 15/20; F05B 2240/60

(57) ABSTRACT

The modular Wind Turbine includes more than a single generator with resource management for variable wind speeds. The design operations are safe by allowing most of the weight to be ground based. The electric motor in this design, is unique with multiple Stators within a single Motor housing. The disclosure includes a modular turbine comprising an R number of discrete rotors and an S number of discrete stators for an N predetermined multiple energy output. The disclosure also includes a common drive shaft for the modular turbine extending from the modular turbine to a remote wind blade. The disclosure further includes a selector configured to inductively link an S number of discrete stators to an R number of discrete rotors for the N multiple energy output.

### BACKGROUND

Wind turbines (WT's) were designed to use the resultant force of wind speeds to produce electrical energy. Their design is a balance of what need is being met (home owner/commercial/etc.), what generator, such as a Permanent Magnetic Synchronous Generator (PMSG) output is best suited to meet that need, what environmental winds exist, and the facility conditions available for installation. The universal failure of WT's is that once wind speed achieves a velocity sufficient for the generator/PMSG to produce it's rated output, additional wind speeds do not provide additional production. Additional wind speeds even become counter-productive by requiring the employment of brakes and causing wear, requiring increased maintenance.

There have been no products available as original equipment or as an aftermarket to address this problem either. There exists a need for a device such as this Modular Wind Turbine that is not being met by any known or disclosed device or system of present.

### SUMMARY OF THE INVENTION

This Modular Wind Turbine will increase annual output of the turbine by up to or in excess of 500%. Consumers would be getting over twice the value, and this invention would also take over twice the strain off the “Grid”, without increasing the physical footprint of the wind turbine. By using a modular design for multiple generating sections, the wind turbines become “Efficient” in variable wind environments. Additionally this invention provides the option of relocating the bulk of the weight (the generating sections) to the ground, to be connected via drive shafts to the wind turbine transmission. This is especially useful for the RidgeBlade style wind turbine as it mounts to the roofs of houses and buildings, and weight is a critical issue. As applied to Electrical Motors (especially with Electric Vehicles), this would function similar to having multiple different sized electric motors connected, that you could engage individually, to constantly provide just the right amount of torque, using the minimal amount of electricity. However, this is an actual motor re-design that incorporates multiple Stator assemblies within a single Motor, to provide the benefits with also providing space savings.

The disclosure includes a modular turbine comprising an R number of discrete rotors and an S number of discrete stators for an N predetermined multiple energy output. The disclosure also includes a common drive shaft for the modular turbine extending from the modular turbine to a remote wind blade. The disclosure further includes a selector configured to inductively link an S number of discrete stators to an R number of discrete rotors for the N multiple energy output.

### BRIEF DESCRIPTION OF THE DRAWINGS

FIG. 1 is a top elevational view of the Modular Wind Turbine apparatus in accordance with an embodiment of the present disclosure.

FIG. 2 Is a top perspective view of the Modular Wind Turbine generator design in accordance with an embodiment of the present disclosure.

FIG. 3 is a side elevational view of the Generator application of the modular wind turbine in accordance with an embodiment of the present disclosure.

FIG. 4 is a front perspective view of the Electric Motor Application of the modular wind turbine in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

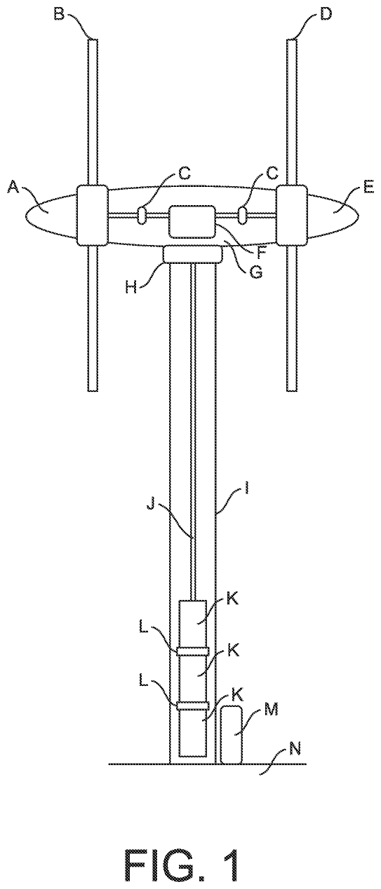

FIG. 1 is a top elevational view of the Modular Wind Turbine apparatus showing: Rotor hub referenced as A., Rotor Blade referenced as B., Brakes (single or dual) referenced as C., Optional 2^{nd} rotor blade referenced as D., Optional 2^{nd} rotor hub referenced as E., Gear box referenced as F., Nacelle referenced as G., Wind direction controller referenced as H., Tower referenced as I., Shaft drive referenced as J., Generators referenced as K., Clutches referenced as L., Transformer referenced as M., Foundation referenced as N., in accordance with an embodiment of the present disclosure.

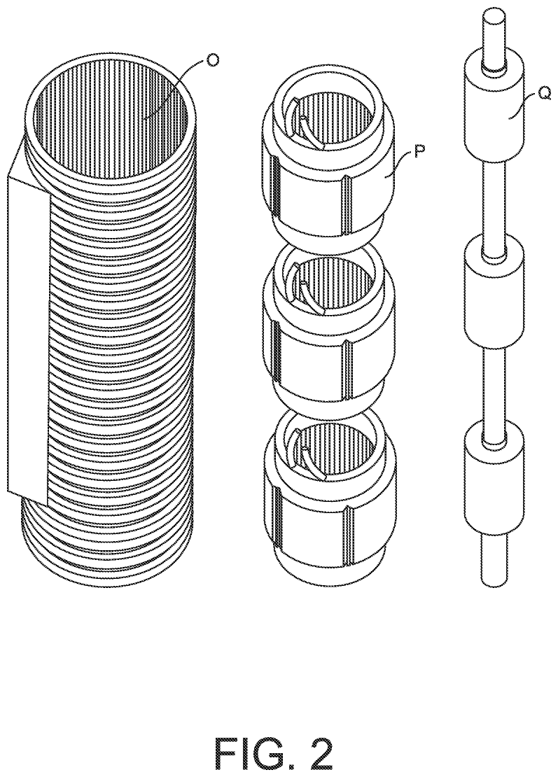

FIG. 2 Is a top perspective view of the Modular Wind Turbine showing the Generator Design including: Generator housing referenced as O., Independent sliding stator assembly referenced as P., Multi-sectional rotor assembly referenced as Q., in accordance with an embodiment of the present disclosure. This is an alternate generator design. Modular wind turbines may use modular PSMGs in a modular configuration or they may choose an alternate design of disclosed embodiments or a combination of both.

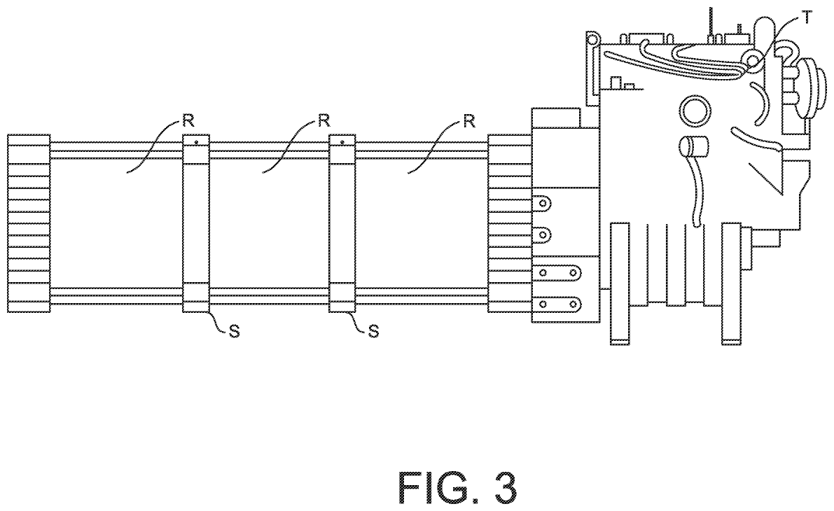

FIG. 3 is a side elevational view of the Generator application of the modular wind turbine showing: Generator heads referenced as R., Clutch assemblies referenced as S., Generator drive motor referenced as T., in accordance with an embodiment of the present disclosure.

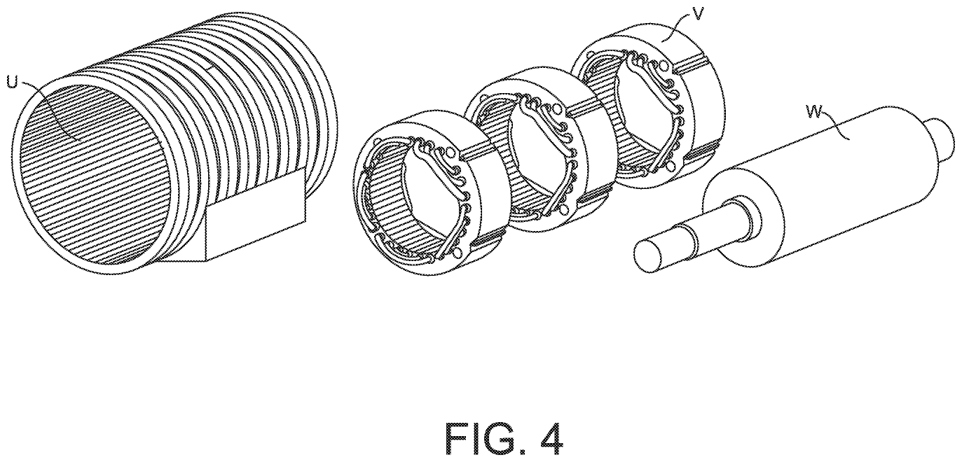

FIG. 4 is a front perspective view of the Electric Motor Application of the modular wind turbine showing: Housing referenced as U., Modular independent stator assembly referenced as V., Rotor referenced as W., in accordance with an embodiment of the present disclosure.

The present disclosed Modular Wind Turbine, also known as “Wind Turbine Modular Re-Design”, improves upon the original wind turbine design. This invention re-designs two versions of Wind Turbines (traditional bladed and RidgeBladed). The re-design of the traditional bladed WIND TURBINE will produce increased output, proportional to the increase of wind speeds, with an option to separate the PMSG (Permanent Magnetic Synchronous Generators) from Rotor and Housing and mount them at the base of the WIND TURBINE via a lengthy drive shaft.

The re-design of the RidgeBlade will separate the PMSG(s) from the rotor sections, deceasing unit weight on the roofs, allowing for larger rotor sections to produce greater torque, in turn allowing the use of larger PMSG's, and optionally traditional generators, as a ground based, and more maintainable alternative.

Continuing with the optional “low wind speed” gearing option, assume the WIND TURBINE is operating below 9 mph, then winds increase. Once main operating Cut-In wind speed of 10 mph is achieved, the gearbox switches from low gearing to normal. The second generator (gen 2) is then engaged as a motor, the rotor is electrically brought up to matching RPM, and the clutch engaged to connect both generators (gen 1 and gen 2) into a single generating unit. The generator is essentially run in electric motor mode to spin up the rotor. That output is then fed to the rectifier and so on. This process continues as wind speed increases, or generators disengage as wind speeds decrease.

The disclosure allows this same example WIND TURBINE, in its same environment, to produce 580% more annual output. An embodied design includes a singular PMSG with a length of six PMSG's. It has a singular rotor and the stator is divided into six sections. Each stator section remains electrically dormant until electrically engaged upon sufficient wind speed. While this eliminates the need for clutches, the rotor includes considerable more mass.

To further remove rotating resistance between the rotor and dormant stator assemblies, the stators are designed with the capacity to separate into four sections each, to be physically separated from the magnetic influence of the rotor, until engaged. This adds another level of complexity to the generator housing, and requires a cost/benefit analysis of its value before proceeding with a chosen design option. Charting the wind speed/output of this configuration is a curve as wind speed power increases exponentially, however, for simple illustrating purposes, a “straight line” method is used. Doing so greatly under-estimates the potential of the configuration, but should make the calculations more simple and easier to understand.

As a mitigation strategy we relocate the PMSG (generator) from within the main housing of the WIND TURBINE, as shown in a WIND TURBINE in to the ground, or the top of a building to which the WIND TURBINE would be mounted. As a benefit this also removes weight from the suspended portion of the WIND TURBINE and lessens the support requirements for mounting the WIND TURBINE. It also increases the safety factor of the WIND TURBINE. The generator (PMSG) would be relocated to the base of the WIND TURBINE and the tower would encase the shaft drive down to the generator. As previously stated, this relocates the mass of the unit and increases its safety factor if the tower failed.

For comparative analysis purposes, a current production Ridgeblade WIND TURBINE is explained. By removing the generator portion and relocating it to the ground, a traditional generator may be utilized vs a PMSG (choice would be determined by analysis) and either ground mounted (for small buildings), or roof mounted if on an office building. With the weight of the generator section being ground based, this allows rotor diameter, blade contact area, blade pitch, and blade spacing to become variables in calculations based on expected winds of the intended environments.

A generic production line of a few variant diameters and blade designs may suite most of the market very well. This is especially true as sections may be added, increasing overall length, to increase the amount of torque produced, allowing for higher yield generators. Composite materials from the aviation/aerospace industry may also be utilized for construction, to minimize mounting weight.

Additionally, a change in the vibration characteristics of the Wind Turbines, requires engineering attention including vibration mitigation, and possibly monitoring of the WIND TURBINE mounts. Mounting with vibration mitigation is incorporated into the design, especially for side mounting on office buildings or hotels. Replaceable mounts, similar to vehicle engine mounts, are incorporated, and include scheduled changes. Active monitoring may also be used, allowing replacement of mounts only upon deterioration. This provides a predictive analysis for preventative maintenance scheduling.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A wind turbine comprising:
a modular turbine comprising an R number of discrete rotors and an S number of discrete stators for an N predetermined multiple energy output;
a common drive shaft for the modular turbine extending from the modular turbine to a remote wind blade; and
a selector configured to inductively link an S number of discrete stators to an R number of discrete rotors for the N multiple energy output.

2. The wind turbine of claim 1, wherein the predetermined N multiple energy output is a cumulative electrical power output produced by a product of the S discrete stators and the R discrete rotors.

3. The wind turbine of claim 1, wherein the common drive shaft is configured to transfer a torque force created at the remote wind blade through a housing to the modular turbine.

4. The wind turbine of claim 1, wherein the R number of discrete rotors is one and the number of discrete stators is greater than one.

5. The wind turbine of claim 1, wherein the selector is a mechanical clutch to engage and disengage the R discrete rotors on the common drive shaft.

6. The wind turbine of claim 1, wherein the selector is an electrical clutch to engage and disengage the R discrete rotors on the common drive shaft.

7. The wind turbine of claim 1, wherein the selector is an electrical clutch configured to engage and to disengage the S discrete stators inductively with a respective rotor.

8. The wind turbine of claim 1, wherein the modular turbine is disposed proximal a foundation of the wind turbine and the wind blade is disposed distal the foundation.

9. The wind turbine of claim 1, wherein the R number of discrete rotors is one and the S number of discrete stators is one and comprise an interchangeable turbine module.

10. The wind turbine of claim 1, wherein the R number of discrete rotors and the S number of discrete stators is proportional to a wind speed at the wind blade.

11. The wind turbine of claim 1, wherein the R number of discrete rotors and the S number of discrete stators increase with an increase of wind speed proximal the wind turbine.

12. The wind turbine of claim 1, wherein the R number of discrete rotors and the S number of discrete stators decrease with a decrease of wind speed proximal the wind turbine.

13. The wind turbine of claim 1, wherein the S number of discrete stators is larger than the R number of discrete rotors.

14. The wind turbine of claim 1, wherein the S number of discrete stators is less than the R number of discrete rotors.

15. The wind turbine of claim 1, further comprising a second wind blade on a common blade shaft with the remote wind blade.

16. The wind turbine of claim 1, further comprising a slide configured to move the R number of rotors inside and outside the S number of stators.

17. The wind turbine of claim 1, further comprising a dynamic connection between the R number of rotors and the common drive shaft.

18. The wind turbine of claim 1, further comprising a static connection between the R number of rotors and the common drive shaft.
